(19) United States
(12) Patent Application Publication
(10) Pub. No.: US 2016/0076456 A1
(43) Pub. Date: Mar. 17, 2016

(54) SYSTEM AND METHOD FOR PROVIDING A WASH TREATMENT TO A SURFACE

(71) Applicant: General Electric Company, Schenectady, NY (US)

(72) Inventors: Sanji Ekanayake, Mableton, GA (US); Murali Krishna Kalaga, Bangalore (IN); Surinder Singh Pabla, Greer, SC (US); Alston Ilford Scipio, Mableton, GA (US)

(21) Appl. No.: 14/484,894

(22) Filed: Sep. 12, 2014

(51) Int. Cl. F02C 7/30; C11D 1/14; C11D 1/722; F02B 77/04; C11D 11/00

(52) U.S. Cl. CPC F02C 7/30; F02B 77/04; C11D 11/0041; C11D 1/722; C11D 1/14; C11D 1/146; F02B 2077/045; F05D 2220/32; F05D 2270/11; F05D 2260/95

(57) ABSTRACT

Methods and systems for washing a surface, such as a gas turbine surface, are provided. A wash control system includes a storage tank configured to contain a cleaning agent, a plurality of nozzles, and a supply conduit coupled to the storage tank on a first end and the plurality of nozzles on a second end, wherein the wash control system is configured to deliver the cleaning agent from the storage tank and to discharge the cleaning agent through the plurality of nozzles and the cleaning agent includes an ethylene oxide-propylene oxide block copolymer, sodium dodecyl benzene sulphonate, sodium lauryl sulphate, or a combination including at least one of the foregoing.

### BACKGROUND OF THE INVENTION

A turbomachine such as a gas turbine typically includes a compressor, combustor, and turbine. The compressor increases the pressure of gases, typically air, and the compressed gas is mixed with gas fuel by the combustor and burned, resulting in hot gases. The heated gases are used to drive a turbine which generates power.

Gas turbine components are cleaned to maintain performance and to extend the overall lifetime of the component, e.g., by reducing the degradation of gas turbine components due to foulants. Cleaning removes foulants, such as smoke, water vapor, soot, grease, oil film, and organic vapors. Gas turbine components may be cleaned while the gas turbine is not in operation. This cleaning, referred to as offline cleaning, may be performed manually. An example of manual cleaning is crank washing. Crank washing is generally performed by the introduction of a cleaning solution into a turbine while slow cranking takes place. This cranking occurs without ignition or fuel being introduced. Since the gas turbine is not in operation while crank washing is performed, the productivity of the gas turbine is reduced.

Cleaning of gas turbine components while the gas turbine is online can be done as well. Such methods often involve the use of additional equipment and/or manual cleaning.

Therefore, a need exists for a system and method for cleaning a turbomachine surface, such as the surface of a gas turbine, which is performed manually or automatically while the gas turbine is online or offline, and/or which employs existing equipment of the gas turbine, thereby extending the period of time between repairs and/or maintenance intervals, extending the lifetime of the component and/or improving the productivity of the gas turbine.

### BRIEF DESCRIPTION OF THE INVENTION

According to one aspect of the invention, a method comprises mixing a cleaning agent with a liquid to form a cleaning solution, wherein the cleaning agent comprises an ethylene oxide-propylene oxide block copolymer, sodium dodecyl benzene sulphonate, sodium lauryl sulphate, or a combination comprising at least one of the foregoing, and applying the cleaning solution to a surface.

According to another aspect of the invention, a wash control system comprises a storage tank configured to contain a cleaning agent, a plurality of nozzles, and a supply conduit coupled to the storage tank on a first end and the plurality of nozzles on a second end; wherein the wash control system is configured to deliver the cleaning agent from the storage tank and to discharge the cleaning agent through the plurality of nozzles, and the cleaning agent comprises an ethylene oxide-propylene oxide block copolymer, sodium dodecyl benzene sulphonate, sodium lauryl sulphate, or a combination comprising at least one of the foregoing.

According to another aspect of the invention, a system comprises a processor and a system memory communicatively coupled to the processor, the system memory having stored thereon executable instructions that when executed by the processor cause the processor to perform operations comprising receiving data from a sensor and providing instructions to dispense a cleaning agent to a surface based on the data received from the sensor, wherein the cleaning agent comprises an ethylene oxide-propylene oxide block copolymer, sodium dodecyl benzene sulphonate, or sodium lauryl sulphate, or a combination comprising at least one of the foregoing.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an exemplary illustration of a gas turbine;

FIG. 2 is an exemplary illustration of a partial cross section of a gas turbine compressor;

FIG. 3 is an exemplary illustration of a system for washing and treating a gas turbine;

FIG. 4 is an exemplary illustration of a system for washing and treating a gas turbine;

FIG. 5 illustrates a non-limiting, exemplary method of implementing a gas turbine washing and treating method;

FIG. 6 illustrates a non-limiting, exemplary method of implementing a gas turbine washing and treating method;

FIG. 7 illustrates a non-limiting, exemplary method of implementing a gas turbine washing and treating method; and

FIG. 8 is an exemplary block diagram representing a general purpose computer system in which aspects of the methods and systems disclosed herein or portions thereof are incorporated.

The detailed description explains embodiments of the invention, together with advantages and features, by way of example with reference to the drawings.

### DETAILED DESCRIPTION OF THE INVENTION

Disclosed herein are methods and systems for the application of a wash treatment to a surface, such as a surface of a turbomachine, compressor or gas turbine, for the removal of surface deposits. In an embodiment and as described in further detail below, the wash treatment comprises one or more cleaning agents. The cleaning agent comprises an ethylene oxide-propylene oxide block copolymer such as Pluronic® F68 non-ionic surfactant or Pluronic® F68+ cationic lipid surfactant, (each of which is also referred to as a “poloxamer”), sodium dodecyl benzene sulphonate (SDBS) and/or sodium lauryl sulphate (SLS).

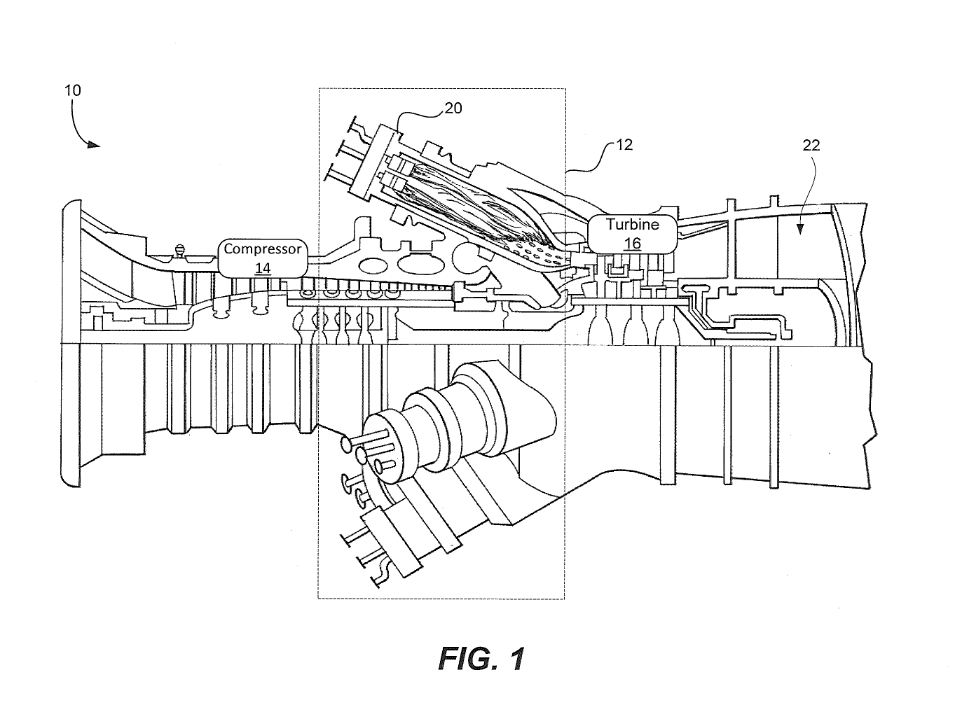

FIG. 1 is an exemplary illustration of a gas turbine 10. Although embodiments described herein refer to a gas turbine as an exemplary surface, the system and methods described herein may be used to provide (or apply) a wash treatment to any desired surface, including but not limited to turbomachines such as gas turbines. As shown in FIG. 1, gas turbine 10 has a combustion section 12 in a gas flow path between a compressor 14 and a turbine 16. The combustion section 12 includes an annular array of combustion components around the annulus. The combustion components include a combustion chamber 20, also known as a combustor, and attached fuel nozzles. The turbine is coupled to rotationally drive the compressor 14 and a power output drive shaft (not shown). Air enters the gas turbine 10 and passes through the compressor 14. High pressure air from the compressor 14 enters the combustion section 12 where it is mixed with fuel and burned. High energy combustion gases exit the combustion section 12 to power the turbine 16 which, in turn, drives the compressor 14 and the output power shaft. The combustion gases exit the turbine 16 through the exhaust duct 22.

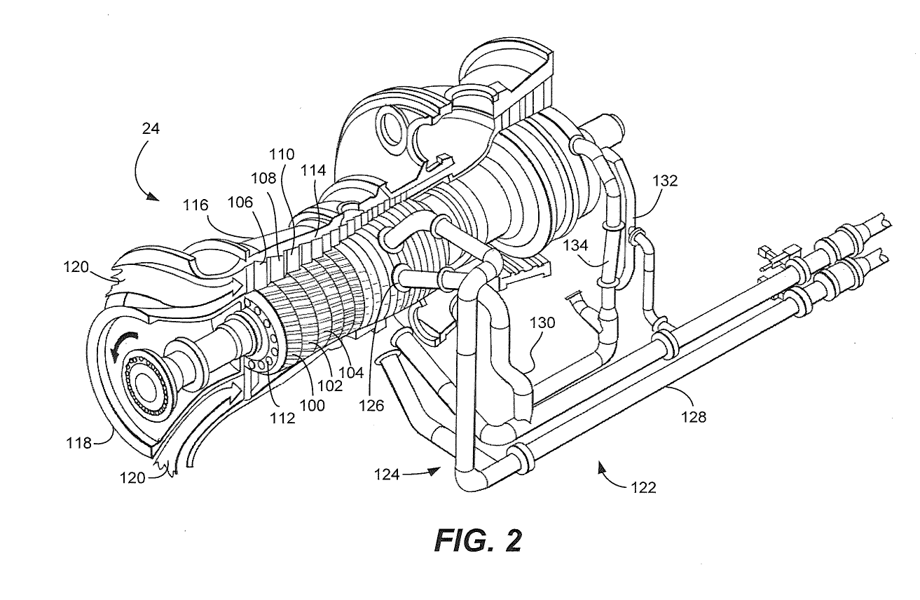

FIG. 2 is an exemplary illustration of a partial cross-section of a gas turbine compressor 24, which is used with the gas turbine 10 and the like. The compressor 24 includes one or more stages. As shown in FIG. 2, there is an A-stage 100, a B-stage 102, or a C-stage 104. The terms “A-stage”, “X-stage”, and the like are used herein as opposed to “first stage”, “second stage,” and the like so as to prevent an inference that the systems and methods described herein are in any way limited to use with the actual first stage or the second stage of the compressor or the turbine. Any number of the stages may be used. Each stage includes a number of circumferentially arranged rotating blades, such as blade 106, blade 108, and blade 110. Any number of blades may be used. The blades are mounted onto a rotor wheel 112. The rotor wheel 112 is attached to the power output drive shaft for rotation therewith. Each stage optionally further includes a number of circumferentially arranged stationary vanes 114. Any number of vanes 114 may be used. The vanes 114 are mounted within a casing 116. The casing 116 extends from a bellmouth 118 towards the turbine 16. The flow of air 120 thus enters the compressor 24 about the bellmouth 118 and is compressed through the blades, such as blade 106, 108, and 110, among others, and the vanes 114 of the stages before flowing to the combustor 12.

The gas turbine 10 further comprises an air extraction system 122. The air extraction system 122 extracts a portion of the flow of air 120 in the compressor 24 for use in cooling the turbine and for other purposes. The air extraction system 122 includes one or more air extraction pipes 124. The air extraction pipes 124 extend from an extraction port 126 about one of the compressor stages towards one of the stages of the turbine. In this example, an X-stage extraction pipe 128 and a Y-stage extraction pipe 130 are shown. The X-stage extraction pipe 128 is positioned about an nth stage and the Y-stage extraction pipe 130 is positioned about an mth stage. Extractions from other stages of the compressor 24 may also be employed. In an embodiment, the X-stage extraction pipe 128 is in communication with an X-stage turbine pipe 132 while the Y-stage extraction pipe 130 is in communication with a Y-stage turbine pipe 134. The X-stage turbine pipe 132 corresponds to a particular stage of the turbine and the Y-stage turbine pipe 134 corresponds to a different stage of the turbine, for example. In another embodiment, the air extraction system 122 has quick-disconnect provisions. The quick-disconnect provisions are located on the air extraction pipes 124, and are part of any or all of the individual extraction pipes, such as the Y-stage extraction pipe 130, for example. In an aspect of the embodiment, the quick-disconnect provisions directly connect to an extraction port 126.

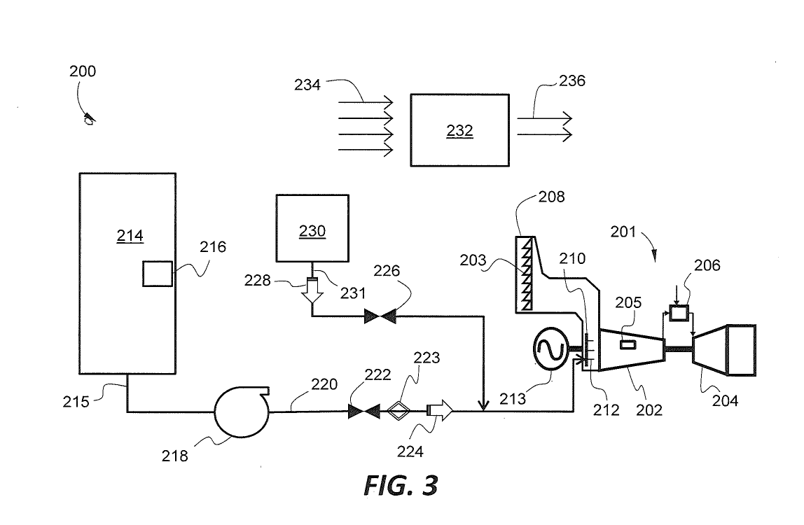

FIG. 3 is an exemplary schematic illustration of an embodiment of a gas turbine wash control system 200 for use with a gas turbine 201, such as gas turbine 10 and the like. The gas turbine 201 includes a compressor 202, a combustor 206, a turbine 204, and an air inlet system 208. The gas turbine 201 is used to drive an electrical or mechanical load such as a generator 213. Inlet guide vanes 203 modulate air flow 120 into the gas turbine 201. The compressor 202 comprises a fouling sensor 205. The fouling sensor 205 is used to determine the concentration of foulant inside the gas turbine 201. The fouling sensor 205 determines the concentration of foulant on a particular surface of the gas turbine 201. The fouling sensor 205 transmits this concentration to the controller 232. The transmitted concentration is compared against a threshold, which may be preselected. If the concentration of foulant detected by the fouling sensor 205 exceeds the threshold, a wash treatment is started, e.g., automatically.

The gas turbine wash control system 200 includes a storage tank 214 that contains a cleaning agent. Multiple storage tanks 214 for multiple cleaning agents or for one type of cleaning agent can be used. The storage tank 214 is optionally provided with a level sensor 216 and is coupled through a conduit 215 to a supply pump 218. The supply pump 218 is connected to an online wash system 210 through a cleaning agent flow modulating valve 222 disposed in cleaning agent conduit 220. The online wash system 210 includes a plurality of nozzles 212 that direct the cleaning agent to the compressor 202. A pressure sensor 223 and a flow sensor 224 are disposed in the cleaning agent conduit 220 to provide the data to control the flow of cleaning agent to the online wash system 210. The gas turbine wash control system 200 further comprises a source of deionized water 230 or other aqueous liquid coupled to a water conduit 231 which is coupled to the cleaning agent conduit 220 through a water flow modulating valve 226. A water flow sensor 228 is disposed in the water conduit 231. In an embodiment, the gas turbine wash control system 200 further comprises quick disconnect provisions in place of or in addition to the storage tank 214 and/or the deionized water or other aqueous liquid source 230. The quick-disconnect provisions are incorporated into one or more positions throughout the online wash system 210, including but not limited to the cleaning agent flow modulating valve 222, the water flow modulating valve 226, and the cleaning agent conduit 220. The quick-disconnect provisions are used for external supply of the cleaning agent storage tank 214 and/or the deionized water or other aqueous liquid source 230, such as from, for example, a supply truck.

In another embodiment, the gas turbine wash control system 200 also includes a controller 232. The controller 232 receives inputs 234, such as the level of fouling of the compressor 202, the level of the storage tank 214, the flow rate of the supply pump 218, the status of the supply pump 218, the pressure inside cleaning agent conduit 220, the pressure inside water conduit 231, the flow rate of the cleaning agent to the compressor 202, the flow rate of deionized water, the status of the water flow modulating valve 226, the status of the cleaning agent flow modulating valve 222, the operating status of the gas turbine 201, the status of the plurality of nozzles 212, and/or any other inputs relating to the status or operation of the gas turbine wash control system 200. In one aspect of the embodiment, the controller 232 determines the ratio of the cleaning agent(s) to deionized water or other aqueous liquid in the cleaning solution produced therefrom. For example, the controller 232 determines the amount of cleaning agent(s) to include or not include in the cleaning solution. In another aspect of the embodiment, the controller 232 determines the ratio of substances to mix to prepare the cleaning agent(s). The cleaning agent is mixed automatically at a predetermined ratio, adjustable based on the type of cleaning agent, duration of the wash, operator preferences, intensity of fouling, and so forth, and injected into the bellmouth 118 of the compressor 202. The mixing may be done in advance or at the time a demand is made. Inlet and drain values may be optimally positioned and aligned prior to introduction of the cleaning agent. In one embodiment, the controller 232 mixes a metered amount of a Pluronic® F68 non-ionic surfactant with a metered amount of deionized water to form a cleaning solution for the wash treatment. In another embodiment, a Pluronic® F68 non-ionic surfactant and deionized water are pre-mixed, and then stored in the storage tank 214.

The controller 232 provides outputs 236 such as instructions or control signals to the cleaning agent flow modulating valve 222, water flow modulating valve 226, online wash system 210, supply pump 218, and/or to any other component or system. The controller 232 is self-contained or, alternatively, is integrated into a larger control system. The controller 232 also monitors various sensors and other instruments associated with a turbine system, such as gas turbine 201. In addition to controlling certain turbine functions, such as fuel flow rate, the controller 232 optionally generates data from its turbine sensors and presents that data for display to the turbine operator. The data may be displayed using software that generates data charts and other data presentations.

An example of the controller 232 is a computer system that includes microprocessors that execute programs to control the operation of the turbine system using sensor inputs, such as inputs 234, and instructions from human operators. The computer system includes logic units, such as sample and hold, summation and difference units that may be implemented in software or by hardwire logic circuits. The commands generated by the computer system processors cause actuators on the turbine system to, for example, adjust the fuel control system that supplies fuel to the combustion chamber, set the inlet guide vanes to the compressor, and adjust other control settings on the turbine system. The description of the computer system features and functions is exemplary only and is non-limiting as to the disclosure.

The cleaning agent comprises an ethylene oxide-propylene oxide block copolymer such as Pluronic® F68 non-ionic surfactant or Pluronic® F68+ cationic lipid surfactant, (each of which is also referred to as a “poloxamer”), sodium dodecyl benzene sulphonate (SDBS), sodium lauryl sulphate (SLS), or a combination comprising at least one of the foregoing. Polymers such as Pluronic® F68 or Pluronic® F68+ polymers have surfactant properties that make them useful in industrial applications. Among other things, they can be used to increase the water solubility of hydrophobic, oily substances or otherwise increase the miscibility of two substances with different hydrophobicities. In some embodiments, the cleaning agent is combined with a liquid, e.g., an aqueous liquid. In an embodiment, the liquid is water. In another embodiment, the liquid is deionized water. “Deionized water” is interchangeable with “demineralized water”. In yet another embodiment, the cleaning agent is mixed with the deionized water at a predetermined ratio, for example, up to a concentration of about 25%, specifically about 0.5% to about 25%, more specifically about 5% to about 20%, and even more specifically about 10% to about 15%.

In an embodiment, the mixing of the cleaning agent and the deionized water is performed at a predetermined speed and/or the pH of the cleaning agent, the deionized water, or the mixture of the two may be adjusted. For example, this pH adjustment may be performed using acetic acid. In another embodiment, a (or an additional) non-ionic surfactant is added to the cleaning agent in order to improve water solubility. In yet another embodiment, the pH of the cleaning agent, the deionized water or a mixture comprising the two is adjusted to a pH from about 5 to about 9, specifically from about 5.5 to about 8.5, more specifically from about 6.5 to about 7.5.

In an exemplary embodiment, the system 200 is configured for cleaning the gas turbine when the gas turbine is offline or online A gas turbine is considered offline when the machine, such as the compressor or turbine, is operating at significantly below normal operating temperature. For example, for offline cleaning, the gas turbine is cooled down, until the interior volume and surfaces have cooled down sufficiently, such as to around 145° F., so that a water or cleaning mixture being introduced into the gas turbine will not thermally shock the internal metal and induce creep, or induce any mechanical or structural deformation of the material. Alternatively, a gas turbine engine is considered offline when the machine is not generating power and not consuming fuel. The gas turbine or some part thereof may be cleaned as part of a random or routine inspection, such as a hot gas path (HGP) inspection. The cleaning may involve disassembling some or all of the gas turbine or a component thereof.

In an online cleaning environment, the system 200 uses existing online water wash nozzles to dispense a cleaning solution of a mixture of demineralized water and the cleaning agent.

In an offline cleaning environment, existing offline water wash nozzles are used along with modified extraction air ports downstream on the compressor casing to dispense a cleaning solution of a mixture of demineralized water and the cleaning agent.

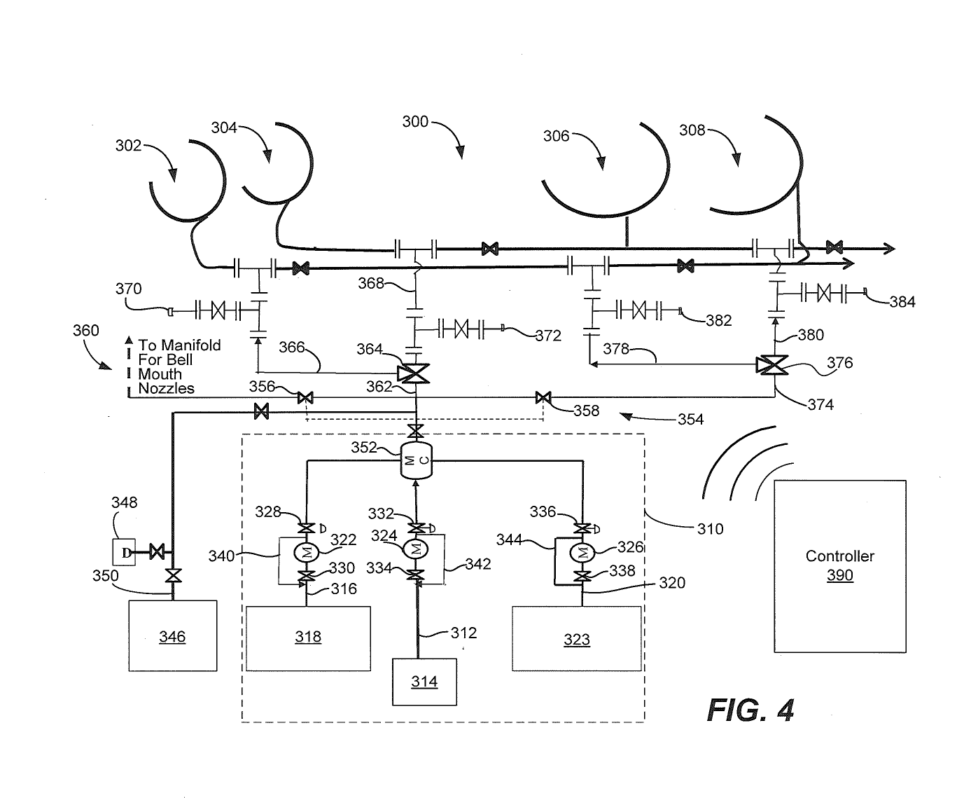

FIG. 4 is a schematic illustration of an exemplary system 300 for washing or otherwise treating a gas turbine, such as gas turbine 10. In an exemplary embodiment, system 300 is configured for washing or otherwise treating the gas turbine when the gas turbine is offline or online.

In an exemplary embodiment of system 300, supply piping 310 is connected to existing compressor air extraction piping 302 and extraction piping 304, which is located near the M and N compressor stages. M and N are used illustratively as substitutions for actual compressor stages, such as the ninth and thirteenth stages. Extraction piping 302 and extraction piping 304 are already present in known gas turbine constructions. In one aspect of the embodiment, the existing air extraction piping is the air extraction piping as shown in FIG. 2. Turbine cooling piping 306 and turbine cooling piping 308 is located near the D and E turbine stages, and is already present in known gas turbine constructions. D and E are used illustratively as substitutions for actual turbine stages, such as the second and third turbine stages. The additional piping arrangements in the system 300 are employed in conjunction with, or as an alternative to, bellmouth nozzles (not shown) through cleaning mixture supply branch 360.

Supply piping 310 includes first cleaning agent supply piping 316, water supply piping 312, and second cleaning agent supply piping 320. First cleaning agent supply piping 316 connects to first cleaning agent source 318. Water supply piping 312 connects to water source 314. Optional second cleaning agent supply piping 320 connects to second cleaning agent source 323. One or more valves, such as valves 328, 330, 332, 334, 336, and 338, connected to supply piping 310 enable a selection (or selections) between different sources of cleaning agent and water. Supply piping 310 optionally further includes one or more pumps. Pumps, which may include motors such as motors 322, 324, and 326, may be used in conjunction with the one or more valves. First cleaning agent supply piping 316, water supply piping 312, and second cleaning agent supply piping 320 optionally further comprise return flow circuits, such as flow circuit 340, flow circuit 342, and flow circuit 344.

Mixing chamber 352 is in fluid connection with first cleaning agent supply piping 316, water supply piping 312, and second cleaning agent supply piping 320. Mixing chamber 352 is in fluid communication with supply manifold 354. Controller 390 determines the ratios of fluids reaching mixing chamber 352 from the first cleaning agent source 318, the water source 314, and the second cleaning agent source 323. Outflow from mixing chamber 352 to supply manifold 354 is also controlled. Supply manifold 354 includes interlocked valves 356 and 358. In an exemplary embodiment, interlocked valves 356 and 358 are controlled so that only one or the other can open at any given time, while both may be closed simultaneously. In an alternative embodiment, interlocked valves 356 and 358 are separately and independently controllable. There may be a plurality of mixing chambers connected with a plurality of fluid sources. For example, there may be a mixing chamber dedicated to a cleaning agent supply, such as third cleaning agent supply 346, and a source of water.

In an embodiment, the system 300 further comprises a third cleaning agent supply 346. Third cleaning agent supply 346 is in fluid communication with third cleaning agent supply piping 350. Connection 348 is in fluid communication with third cleaning agent supply piping 350 and is used for external supply, such as from a supply truck. For example connection 348 may be a quick-disconnect.

From supply manifold 354, cleaning mixture supply branch 360 provides a cleaning solution to a compressor bellmouth, such as bellmouth 118, when the appropriate valves are suitably configured. A cleaning solution (or mixture) supply branch may provide the cleaning solution to a plurality of nozzles, such as nozzles 212. Similarly, supply line 362 leads to three-way valve 364 which, in turn, leads to supply branch 366 and supply branch 368. The cleaning solution in supply branch 366 and supply branch 368 is supplied simultaneously or selectively to air extraction piping 302 and extraction piping 304, respectively. Supply branch 366 and supply branch 368 further comprise a quick-disconnect 370 and a quick-disconnect 372, respectively, which are employed for distribution or drainage of cleaning agents or other fluids. Supply piping 374 extends from manifold 354 to three-way valve 376, and on to supply branch 378 and supply branch 380 to supply a cleaning mixture, such as a Pluronic® F68 non-ionic surfactant mixed with deionized water, to piping 306 and piping 308, respectively. Supply branch 378 and supply branch 380 are provided with quick-disconnect 382 and quick-disconnect 384, respectively, which may be employed for distribution or drainage of cleaning agents or other fluids.

System 300 optionally further comprises a plurality of sensors (not shown), such as a motor sensor, a fluid level sensor, a pressure sensor, an outflow pressure sensor, a compressor pressure sensor which senses pressure in a compressor section of a gas turbine engine, a turbine pressure sensor which senses pressure in a gas turbine engine, an inlet pressure sensor which senses pressure in cleaning mixture supply branch 360, or valve position sensors, among other sensors. System 300 may further include flow sensors configured to sense the rate of flow of a fluid flowing, or not flowing, through piping.

In one embodiment, water and one or more cleaning agents may be mixed at a predetermined ratio. Mixing is carried out via mixing chamber 352. In one embodiment, first cleaning agent supply 318, second cleaning agent source 323, and third cleaning agent supply 346 supply cleaning agents, such as Pluronic® F68 non-ionic surfactant, pH adjustment fluid, such as acetic acid, or a (or another non-ionic surfactant. First cleaning agent supply 318, second cleaning agent source 323, and third cleaning agent supply 346 supply different fluids or the same fluids and may be of equal or different volumes and pressures. In one embodiment, first cleaning agent source 318 supplies a Pluronic® F68 non-ionic surfactant to mixing chamber 352 and water source 314 supplies deionized water to mixing chamber 352.

Controller 390 is suitably programmed so that an operator may make alterations in the ratio of water to cleaning agent, the type of cleaning agent to use, the cycle times for wash sequences, or the order of sequences in wash or rinse cycles. Controller 190 is configured to allow only authorized operators to make changes to wash sequences, or alternatively, is preconfigured by the gas turbine manufacturer to accommodate the specifications and configurations of a selected gas turbine. In an exemplary embodiment, controller 390 sets a ratio of SDBS to deionized water to be used in an offline wash, the SDBS to be supplied from first cleaning agent supply 318 and the deionized water to be supplied from water source 314.

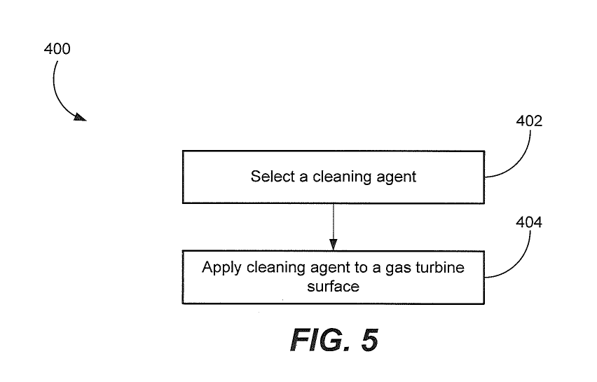

Illustrated in FIG. 5 is a method 400. Each part of the sequence(s) described in regard to method 400 is labeled to denote a particular part of the method; however, the particular order of the parts of the method is not limited thereto. In an embodiment, the order in which the method is carried out is selected for the desired application.

At 402, a cleaning agent is selected.

At 404, the cleaning agent is applied to a gas turbine 201 surface, such as a blade (e.g., 106, 108, 110), vane 114, rotor wheel 112, or casing 116, using a gas turbine wash nozzle 212.

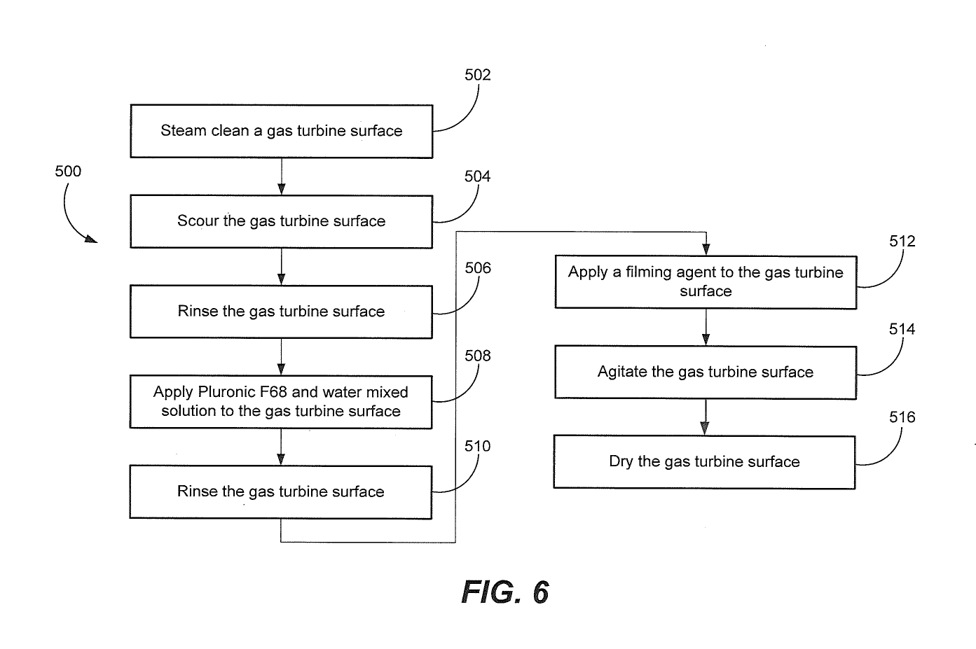

Illustrated in FIG. 6 is a method 500.

At 502, as gas turbine 201 surface is steam cleaned.

At 504, the gas turbine surface is scoured. Scouring is a technique which abrades the surface by rubbing with an abrasive material, such as a scouring pad. Scouring may be automated or performed by hand.

At 506, the gas turbine surface is rinsed. The rinsing is performed using a liquid such as water, and the water may be deionized. In an embodiment, the gas turbine wash control system 200 performs the rinsing using the online wash system 210. The rinsing liquid is supplied by a quick-disconnect provision or a storage tank 214. In another embodiment, the rinsing is performed by hand.

At 508, a cleaning solution of a Pluronic F68® non-ionic surfactant and water is applied to the gas turbine surface. The solution is mixed just prior to application, or is pre-mixed. In an embodiment, the cleaning solution is applied by hand. In another embodiment, the gas turbine wash control system 200 is used to apply the cleaning solution using the online wash system 210. The solution cleaning is applied using wiping or spraying techniques. In an embodiment, the cleaning solution is introduced while the gas turbine is under crank operation.

At 510, the gas turbine surface is rinsed again. The rinsing uses a liquid such as water, and the water may be deionized.

At 512, a cleaning agent is applied to the gas turbine surface. The cleaning agent removes fouling agents deposited thereon.

At 514, the gas turbine surface is optionally agitated to increase coverage and adherence by the cleaning agent. Agitation may include movement by rotation, tilting, swaying, and so forth.

At 516, the gas turbine surface is dried. The drying is carried out by air, applied heat, vacuum drying, fan drying, blower drying, or the like. The drying may optionally be assisted by the alignment of valves in the gas turbine 201 to allow drainage of liquid.

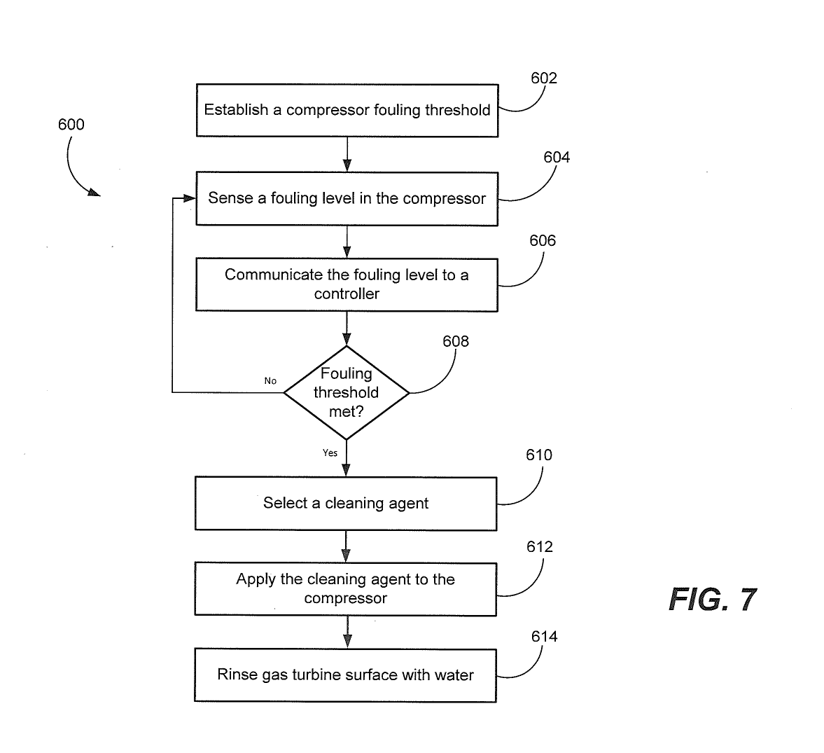

Illustrated in FIG. 7 is a method 600.

At 602, a fouling threshold level is established. The threshold level is an overall fouling level or a specific level of one or more foulants. The fouling level is measured at one or more locations in the gas turbine 201 and one or more locations may be used to establish the threshold level.

At 604, the fouling level of the compressor 202 is sensed.

At 606, the fouling level is communicated to the controller 232. The controller 232 may show this information on a display or send it to an operator.

At 608, it is determined whether the fouling threshold has been met.

At 610, a cleaning agent, such as a Pluronic® F68 non-ionic surfactant, is selected. The cleaning agent may be mixed with deionized water at that time or already be mixed with deionized water.

At 612, the cleaning agent is applied to the compressor 202. The gas turbine wash control system 200 is used to apply the solution using the online wash system 210 while the gas turbine 201 is online.

At 614, the gas turbine compressor 202 is rinsed with water. The water may be deionized water. The gas turbine wash control system 200 is used to rinse the compressor 202 using the online wash system 210 while the gas turbine is online.

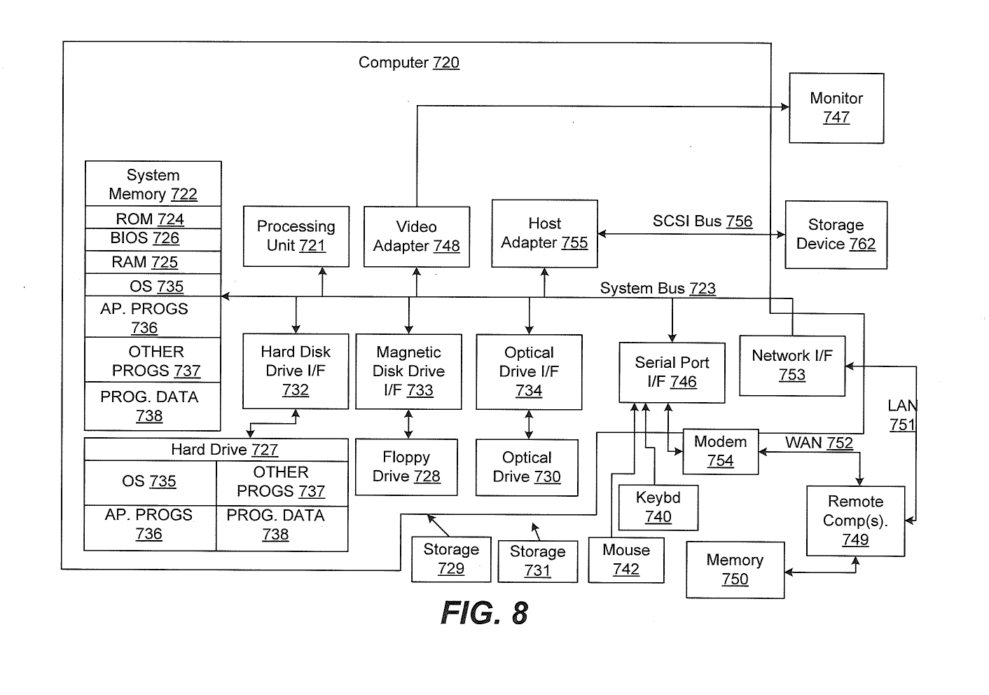

FIG. 8 and the following discussion are intended to provide a brief general description of a suitable computing environment in which the methods and systems disclosed herein and/or portions thereof may be implemented. Although not required, portions of the methods and systems disclosed herein are described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. A processor may be implemented on a single-chip, multiple chips or multiple electrical components with different architectures. The methods and systems disclosed herein may also be practiced in distributed computing environments where tasks are performed by remote processing devices that are linked through a communications network. In a distributed computing environment, program modules may be located in both local and remote memory storage devices.

FIG. 8 is a block diagram representing a computer system in which aspects of the methods and systems disclosed herein and/or portions thereof may be incorporated. As shown, the exemplary general purpose computing system includes a computer 720 or the like, including a processing unit 721, a system memory 722, and a system bus 723 that couples various system components including the system memory 722 to the processing unit 721. The system bus 723 may be any of several types of bus structures including a memory bus or memory controller, a peripheral bus, and a local bus using any of a variety of bus architectures. The system memory includes read-only memory (ROM) 724 and random access memory (RAM) 725. A basic input/output system 726 (BIOS), containing the basic routines that help to transfer information between elements within the computer 720, such as during start-up, is stored in ROM 724.

The computer 720 may further include a hard disk drive 727 for reading from and writing to a hard disk (not shown), a magnetic disk drive 728 for reading from or writing to a removable magnetic disk 729, and an optical disk drive 730 for reading from or writing to a removable optical disk 731 such as a CD-ROM or other optical media. The hard disk drive 727, magnetic disk drive 728, and optical disk drive 730 are connected to the system bus 723 by a hard disk drive interface 732, a magnetic disk drive interface 733, and an optical drive interface 734, respectively. The drives and their associated computer-readable media provide non-volatile storage of computer readable instructions, data structures, program modules and other data for the computer 720. As described herein, computer-readable media is a tangible, physical, and concrete article of manufacture and thus not a signal per se.

Although the exemplary environment described herein employs a hard disk, a removable magnetic disk 729, and a removable optical disk 731, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 729, optical disk 731, ROM 724 or RAM 725, including an operating system 735, one or more application programs 736, other program modules 737 and program data 738. A user may enter commands and information into the computer 720 through input devices such as a keyboard 740 and pointing device 742. Other input devices (not shown) may include a microphone, joystick, game pad, satellite disk, scanner, or the like. These and other input devices are often connected to the processing unit 721 through a serial port interface 746 that is coupled to the system bus 723, but may be connected by other interfaces, such as a parallel port, game port, or universal serial bus (USB). A monitor 747 or other type of display device is also connected to the system bus 723 via an interface, such as a video adapter 748. In addition to the monitor 747, a computer may include other peripheral output devices (not shown), such as speakers and printers. The exemplary system of FIG. 8 also includes a host adapter 755, a Small Computer System Interface (SCSI) bus 756, and an external storage device 762 connected to the SCSI bus 756.

The computer 720 may operate in a networked environment using logical connections to one or more remote computers, such as a remote computer 749. The remote computer 749 may be a personal computer, a server, a router, a network PC, a peer device or other common network node, and may include many or all of the elements described above relative to the computer 720, although only a memory storage device 750 has been illustrated in FIG. 8. The logical connections depicted in FIG. 8 include a local area network (LAN) 751 and a wide area network (WAN) 752. Such networking environments are commonplace in offices, enterprise-wide computer networks, intranets, and the Internet.

When used in a LAN networking environment, the computer 720 is connected to the LAN 751 through a network interface or adapter 753. When used in a WAN networking environment, the computer 720 may include a modem 754 or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in remote memory storage device 750. It will be appreciated that the network connections shown are exemplary and other means of establishing a communications link between the computers may be used.

Computer 720 may include a variety of computer readable storage media. Computer readable storage media can be any available media that can be accessed by computer 720 and includes both volatile and nonvolatile media, removable and non-removable media. By way of example, and not limitation, computer readable media may comprise computer storage media and communication media. Computer storage media include both volatile and nonvolatile media, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 720. Combinations of any of the above should also be included within the scope of computer readable media that may be used to store source code for implementing the methods and systems described herein. Any combination of the features or elements disclosed herein may be used in one or more embodiments.

A technical effect of the embodiments described herein is to provide a system and method for cleaning a surface, such as the surface of a turbomachine or more specifically a gas turbine, which is performed manually or automatically while the gas turbine is online or offline, and/or which employs existing equipment of the gas turbine, thereby extending the period of time between repairs and/or maintenance intervals, extending the lifetime of the component and/or improving the productivity of the gas turbine.

The terminology used herein is for the purpose of describing particular embodiments only and is not intended to be limiting of the invention. Where the definition of terms departs from the commonly used meaning of the term, applicant intends to utilize the definitions provided herein, unless specifically indicated. The singular forms “a,” “an,” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

### EXAMPLES

### Example 1

In this example, a Pluronic® F68 non-ionic surfactant cleaning agent was mixed with deionized water to form cleaning solutions having concentrations of 10% and 20% of the cleaning agent, respectively.

### Example 2

In this example, a SDBS cleaning agent was mixed with deionized water to form cleaning solutions having concentrations of 10% and 20% of the cleaning agent, respectively.

### Example 3

In this example, a SLS cleaning agent was mixed with deionized water to form cleaning solutions having concentrations of 10% and 20% of the cleaning agent, respectively.

### Example 4

A fouled blade was dipped into each of the cleaning solutions prepared according to Examples 1-3. In each case, the fouled blade was dipped into the respective cleaning solution for a period of five minutes. Upon removal of the blade form the cleaning solution, the portions of the blade which were immersed in the cleaning solution were clean.

The results of Examples 1-3 thus demonstrate that the gas turbine wash methods and systems described herein result in significantly reduced fouling of gas turbine components.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed:

1. A method, comprising:
mixing a cleaning agent with a liquid to form a cleaning solution, wherein the cleaning agent comprises an ethylene oxide-propylene oxide block copolymer, sodium dodecyl benzene sulphonate, sodium lauryl sulphate, or a combination comprising at least one of the foregoing; and
applying the cleaning solution to a surface.

2. The method of claim 1, wherein the surface is a turbomachine surface or a gas turbine surface.

3. The method of claim 2, wherein the surface is a gas turbine surface that is at least one of a casing, a vane, a blade, a rotor wheel, or a turbine.

4. The method of claim 1, wherein the cleaning solution is applied to the surface by wiping or spraying.

5. The method of claim 1, further comprising scouring the surface with an abrasive material.

6. The method of claim 1, further comprising rinsing the surface.

7. The method of claim 1, further comprising agitating the cleaning solution on the surface.

8. The method of claim 1, further comprising aligning drain valves of a gas turbine.

9. The method of claim 1, further comprising steam cleaning the surface with the cleaning solution.

10. The method of claim 1, wherein the cleaning agent is applied using wash nozzles of a gas turbine.

11. The method of claim 1, wherein the cleaning agent is applied using air extraction piping of a gas turbine.

12. The method of claim 1, wherein the liquid is deionized water.

13. The method of claim 1, wherein a pH of the cleaning solution is from about 5 to about 9.

14. The method of claim 1, further comprising supplying the cleaning agent using quick-disconnect provisions in flow communication with a gas turbine.

15. A wash control system comprising:
a storage tank configured to contain a cleaning agent;
a plurality of nozzles; and
a supply conduit coupled to the storage tank on a first end and the plurality of nozzles on a second end; wherein the wash control system is configured to deliver the cleaning agent from the storage tank and to discharge the cleaning agent through the plurality of nozzles, and the cleaning agent comprises an ethylene oxide-propylene oxide block copolymer, sodium dodecyl benzene sulphonate, sodium lauryl sulphate, or a combination comprising at least one of the foregoing.

16. The wash control system of claim 15, further comprising a second storage tank in fluid communication with the supply conduit, wherein the second storage tank contains deionized water and wherein the deionized water is added to the cleaning agent prior to discharging the deionized water and the cleaning agent through the plurality of nozzles.

17. The wash control system of claim 16, wherein the concentration of the cleaning agent in the deionized water is from about 0.5% to about 25%.

18. The wash control system of claim 16, further comprising:
a sensor in communication with a surface to be washed;
a valve disposed within the supply conduit and a controller having a processor and a memory communicatively coupled to the processor, the memory having executable instructions that when executed by the processor cause the processor to perform operations comprising:
receiving, from the sensor, data indicative of fouling; and
providing instructions, in response to the receiving, to the valve to open and permit the discharge of the deionized water and the cleaning agent from the plurality of nozzles onto the surface.

19. A system, comprising:
a processor; and
a system memory communicatively coupled to the processor, the system memory having stored thereon executable instructions that when executed by the processor cause the processor to perform operations comprising:
receiving data from a sensor; and
providing instructions to dispense a cleaning agent to a surface based on the data received from the sensor, wherein the cleaning agent comprises an ethylene oxide-propylene oxide block copolymer, sodium dodecyl benzene sulphonate, sodium lauryl sulphate, or a combination comprising at least one of the foregoing.

20. The system of claim 19, wherein the sensor monitors fouling of the surface.
